(19) United States
(12) Patent Application Publication
(10) Pub. No.: US 2005/0216708 A1
(43) Pub. Date: Sep. 29, 2005

(54) Processor for performing context switching, a method for performing context switching, a computer program for perform context switching

(75) Inventor: Isao Katayama, Chigasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/972,341

(22) Filed: Oct. 26, 2004

(30) Foreign Application Priority Data
Mar. 24, 2004 (JP) P2004-086841

(51) Int. Cl. G06F 9/00

(52) U.S. Cl. 712/228

(57) ABSTRACT

A processor for performing context switching, including: (a) a register unit configured to include a primary register used in program execution by the processor and a secondary register having a same structure as the primary register; (b) a data storage unit configured to be used as a data storage area in the program execution; (c) a transfer unit configured to include a transfer register used in data transfer between the secondary register and the data storage unit; and (d) an arithmetic unit configured to perform the copy between the primary and secondary registers in a cycle and performs the data transfer between the data storage unit and the secondary register in parallel to instruction execution by the processor when the instruction execution by the processor does not involve memory access to the data storage unit.

### CROSS REFERENCE TO RELATED APPLICATIONS

This application is based upon and claims the benefit of priority from the prior Japanese Patent Applications No. P2004-86841, filed on Mar. 24, 2004, the entire contents of which are incorporated herein by reference.

### BACKGROUND OF THE INVENTION

1. Field of the Invention

The present invention relates to a processor having a pipeline architecture which performs high speed context switching and a method for performing high speed context switching of a processor and a computer program in a computer memory for performing high speed context switching of a processor

2. Description of the Related Art

For earlier processors, a method (for example, see Japanese Patent Laid-Open publication No. 6-83639) is disclosed to achieve speeding up of context switching operations which saves and restores information for running programs which is necessary for interrupt processing and/or multitask processing. In the method, a plurality of register files are provided, and the contents of the plurality of register files are shifted.

Another method (for example, see Japanese Patent Laid-Open publication No. 5-28092) is disclosed, which speeds up context switching without increasing the number of register files. In the method, processes of saving and restoring the contents of the shifted register files to and from an external memory are performed by DMA transfer after context switching in order to allow nesting. The nesting is a process in which an interrupt handling process is accepted during another interruption handling process.

However, these methods are required to execute a plurality of instructions for each process of saving and/or restoring the context information of the plurality of registers.

These methods are to be achieved the speeding up of context switching without increasing the clock frequency of a processor. However, processors for built-in devices and portable applications cannot efficiently lower the power consumption because the processors require a lot of operating circuits and operating times.

Furthermore, these methods perform data transfer without checking whether the data is need to be stored or not, the processor executing time for an instruction is increased, and it makes the processing performance of the processor slow down.

### SUMMARY OF THE INVENTION

An aspect of the present invention inheres in a processor, comprising: (a) a register unit configured to include a primary register used in program execution by the processor and a secondary register having a same structure as the primary register; (b) a data storage unit configured as a data storage area in the program execution; (c) a transfer unit configured to include a transfer register for data transfer between the secondary register and the data storage unit; and (d) an arithmetic unit configured to cyclically perform copying between the primary and secondary registers and perform the data transfer between the data storage unit and the secondary register in parallel in response to an instruction by the processor when the instruction by the processor fails to involve memory access to the data storage unit.

Another aspect of the present invention inheres in a method for performing context switching within a processor, comprising: (a) copying data of a register within a primary register specified by an instruction operand for a processor executing to a secondary register; (b) transferring the copied data of the secondary register to a data storage unit in accordance with a predetermined sequence; (c) copying data of a register of the secondary register to which the data of the primary register are copied to the primary register; and (d) transferring the data from the data storage unit to the secondary register in parallel when data of the secondary register to be transferred remains in the data storage unit, in response to an instruction by the processor when the instruction by the processor fails to involve memory access to the data storage unit.

A still another aspect of the present invention inheres in a computer program configured to perform context switching within a processor, the computer program causing a computer to execute instructions for: (a) copying data of a register within a primary register specified by an instruction operand for a processor executing to a secondary register; (b) transferring the copied data of the secondary register to a data storage unit in accordance with a predetermined sequence; (c) copying data of a register of the secondary register to which the data of the primary register are copied to the primary register; and (d) transferring the data from the data storage unit to the secondary register in parallel when data of the secondary register to be transferred remains in the data storage unit, in response to an instruction by the processor when the instruction by the processor fails to involve memory access to the data storage unit.

### BRIEF DESCRIPTION OF THE DRAWINGS

FIG. 1 is a block diagram of a processor according to an embodiment of the present invention.

FIG. 2 is a view disclosing a correspondence between a transfer pattern section of a transfer unit and registers.

FIG. 3 is a view disclosing a correspondence between a structure block in a data storage unit and top and bottom pointers.

FIGS. 4A to 4C are views disclosing states when a context is saved to the data storage unit in execution of a stregs instruction.

FIGS. 5A to 5C are views disclosing states when the context is restored to registers in execution of a ldregs instruction.

FIG. 6 is a flowchart disclosing a procedure of interrupting process.

FIG. 7 is a flowchart disclosing a procedure of a function call process.

FIG. 8 is a flowchart disclosing a procedure of a context saving process.

FIG. 9 is a flowchart disclosing a procedure of a context restoring process.

FIG. 10 is a flowchart disclosing a procedure of a modified example of the context saving process.

FIG. 11 is a flowchart disclosing a procedure of a modified example of the context restoring process.

FIG. 12 shows a source code describing the context saving and restoring processes.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

In the following descriptions, numerous specific details are set fourth to provide a thorough understanding of the present invention. However, it will be obvious to those skilled in the art that the present invention may be practiced without such specific details.

(Processor)

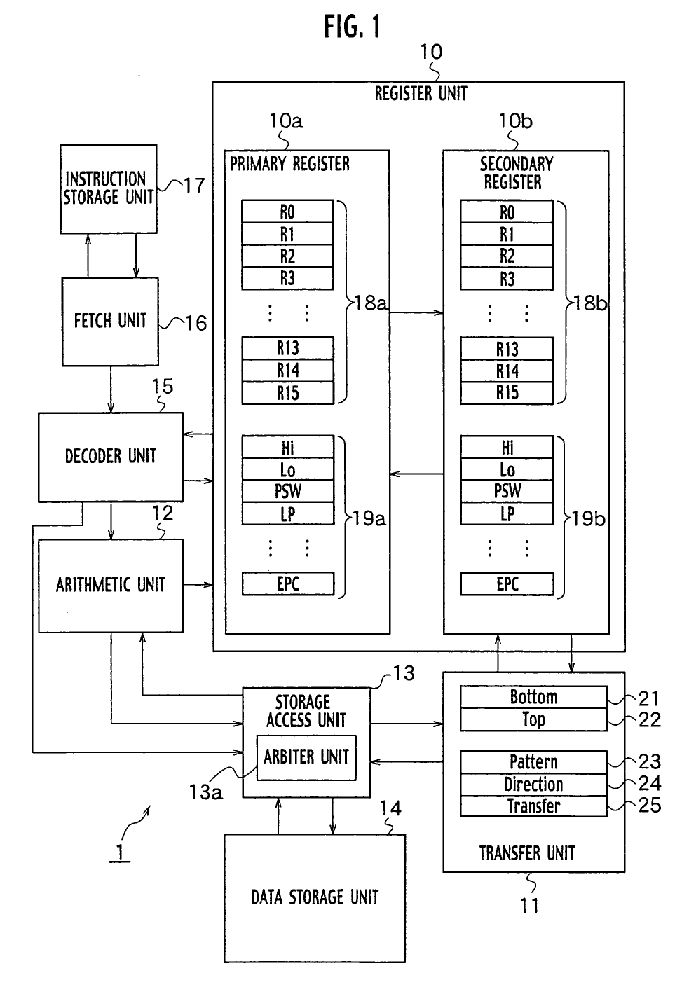

As shown in FIG. 1, a processor 1 in the embodiment of the present invention includes a register unit 10, a transfer unit 11, an arithmetic unit 12, a storage access unit 13, a data storage unit 14, a decoder unit 15, a fetch unit 16, and an instruction storage unit 17.

The register unit 10 includes a primary register 10a and a secondary register 10b. The primary register 10a embraces general-purpose registers (R0 to R15) 18a and dedicated registers (Hi: high, Lo: low, LP: link pointer, PSW: processor status word, EPC: exception program counter) 19a for program execution of the processor 1. The secondary register 10b includes general-purpose registers 18b and dedicated registers 19b. The structure of these resisters 18b and 19b are the same as those of the primary register 10a, resisters 18a and 19a.

The data storage unit 14 is a main memory or an auxiliary memory used as data storage areas during the processor 1 executing. A storage area in the data storage unit 14 is specified by a memory address.

The transfer unit 11 performs processes of inputting/outputting contents of the register unit 10 to/from the storage access unit 13. The transfer unit 11 includes transfer registers in data transfer between the secondary registers 10b and the data storage unit 14. The transfer registers are a bottom pointer section 21, a top pointer section 22, a transfer pattern section 23, a transfer direction flag section 24, a transfer request flag section 25.

The top pointer section 22 stores a top pointer for transfer between the secondary register 10b and the data storage unit 14. The bottom pointer section 21 stores a bottom pointer for transfer between the secondary register 10b and the data storage unit 14.

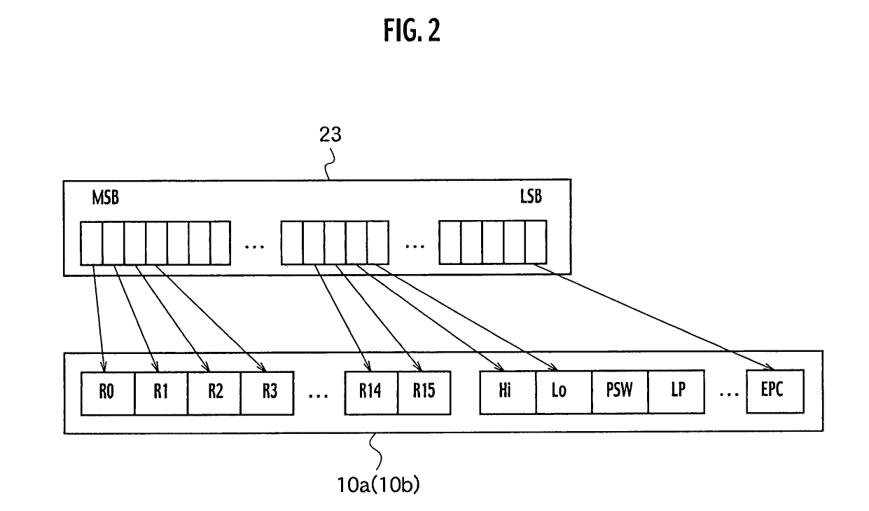

The transfer direction flag section 24 stores a direction flag indicating a direction of data transfer between the register unit 10 and the data storage unit 14. The transfer request flag section 25 stores a transfer flag instructing to start the data transfer between the secondary register 10b and the data storage unit 14 and indicating whether data is being transferred. The transfer pattern section 23 stores a pattern flag controlling for each register whether the copy between the primary and secondary registers 10a and 10b or the transfer between the secondary register 10b and the data storage unit 14 is performed. The relationship between the pattern flag and the primary or secondary register 10a or 10b is shown in FIG. 2. The pattern flag of FIG. 2 is searched from the most significant bit (MSB), which sets the most significant value of a specified parameter toward the least significant bit (LSB), which sets the least significant value thereof.

The above five transfer registers are independently varied with control operations in instruction execution of programs and are configured to allow reading, setting by instruction programs in order to flexibly control a context switching operation.

The instruction storage unit 17 stores a plurality of instruction programs with which the arithmetic unit 12 performs arithmetic processing. The arithmetic unit 12 executes these instruction programs, and thus processing of the processor 1 is performed. The arithmetic unit 12 executes a store register instruction (stregs instruction) and a load register instruction (ldregs instruction). The arithmetic unit 12 also executes some assembler instructions such as an area definition instruction, a move instruction, an addition instruction, and a subtraction instruction.

The stregs instruction copies data of the primary register 10a specified by an instruction operand to the secondary register 10b, and sequentially transfers the copied secondary register 10b to the data storage unit 14.

The ldregs instruction copies the data of the secondary register 10b which were copied by the stregs instruction to the primary register 10a, and transfers the data of the data storage unit 14 to the secondary register 10b if the data storage unit 14 need to pass some essential data to the secondary register 10b.

The copy between the primary and secondary registers 10a and 10b are performed in a cycle. The data transfer between the data storage unit 14 and the secondary register 10b is performed in parallel to instruction execution by the processor 1 when the processor 1 is not executing any instruction and not using memory access bus toward the data storage unit 14.

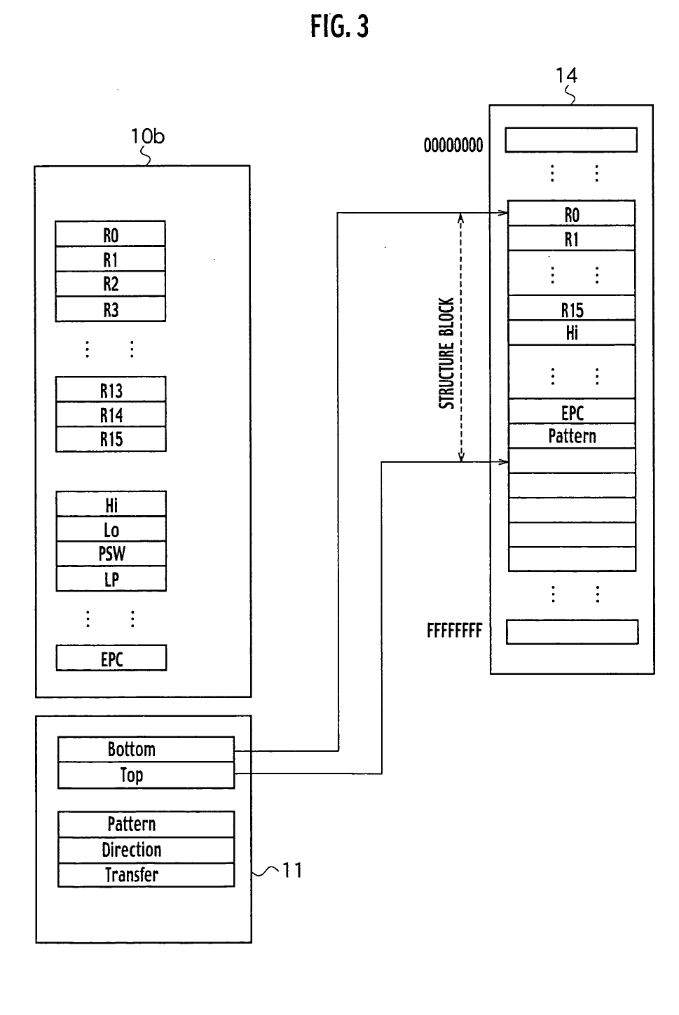

After the stregs instruction is executed and the the data storage unit 14 is transferred, the specified registers of the secondary register 10b and a data structure block of the storage data unit 14 become same status as shown in FIG. 3. The top and bottom pointers indicate memory addresses of the data structure block as shown in FIG. 3. The data just before a first data structure block is initialized with “0” indicating termination.

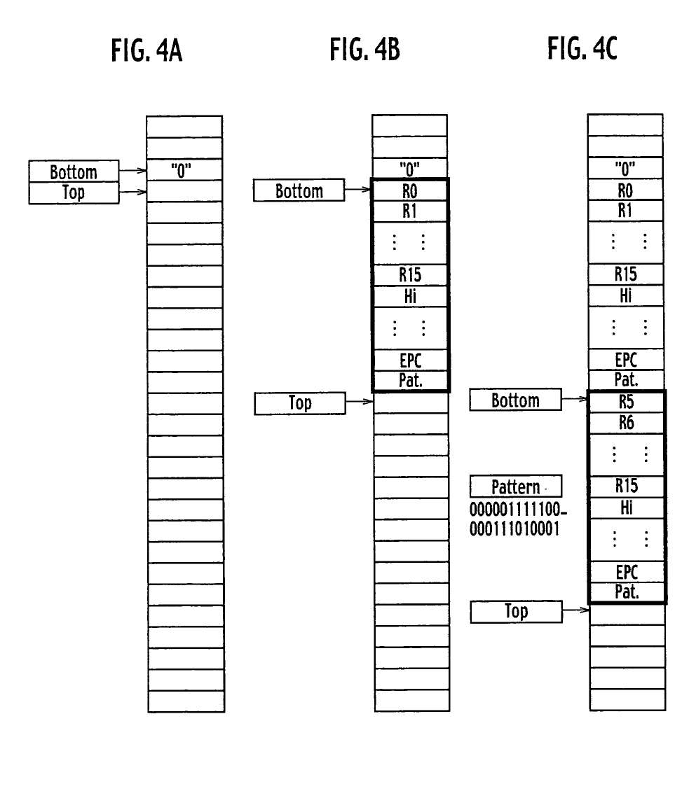

FIG. 4A shows an initial state of the data structure block or a state where all of the saving operation by context switching and the corresponding restoring operation are completed. FIG. 4B shows a state of the data structure block which is saved by context switching by the stregs instruction executed at the beginning of the interrupt processing or a subroutine with an interrupt acceptance operation or a subroutine call instruction operation. FIG. 4C shows the data structure blocks in a state where context switching is performed by the stregs instruction executed by a processing program for the interrupt acceptance operation or the subroutine call instruction operation along with these operations (nesting) permitted again in the state shown in FIG. 4B.

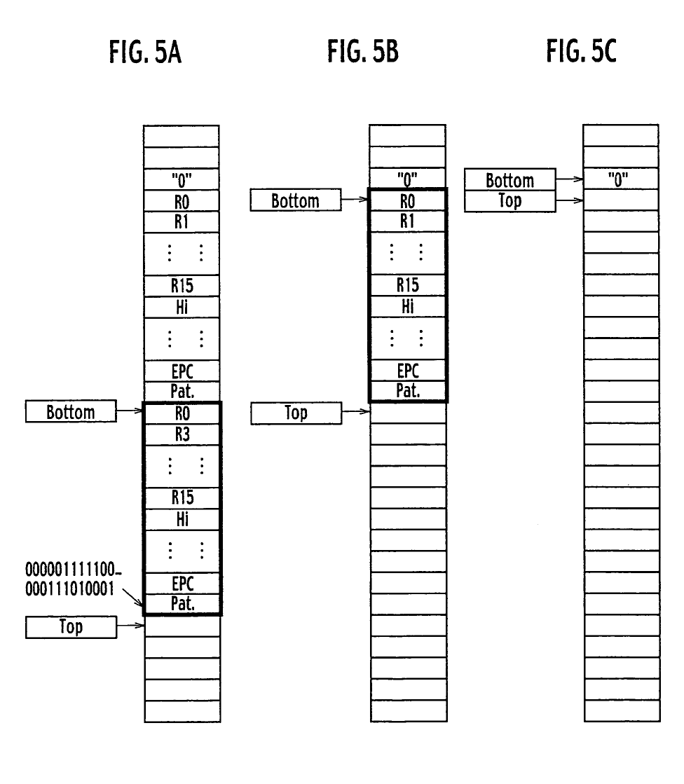

FIG. 5A shows data structure blocks after context switching is performed twice to save contexts in the data storage unit 14. FIG. 5B shows the data structure block after the ldregs instruction is executed in the state shown in FIG. 5A. FIG. 5C shows the data structure block after the ldregs instruction is executed again in the state shown in FIG. 5B for context switching and the saving operation and the corresponding restoring operation are completed.

The processor 1 operates by using only the primary register 10a in execution of arithmetic, control, and other normal instructions. In execution of both the stregs and ldregs instructions, the processor 1 performs the operations of copy between the both registers and data transfer between the secondary register 10b and the data storage unit 14 using the primary and secondary registers 10a and 10b.

The storage access unit 13 performs control of addresses and reading/writing and performs input/output of data for the data storage unit 14. The data storage unit 14 includes an arbiter section 13a. The arbiter section 13a arbitrates input/output of the arithmetic unit 12 and input/output of the transfer unit 11 using information from the decoder unit 15.

The decoder unit 15 decodes a code signal received from the fetch unit 16 and sends the decoded signal to the arithmetic unit 12. Moreover, the decoder unit 15 reads data from the general-purpose registers 18a of the register unit 10 and follows an instruction of arithmetic contents thereof while the decoder unit 15 reads data indicated by the code signal from the register unit 10 and sends the read data to the arithmetic unit 12. In decoding the code signal, the decoder unit 15 judges whether this code instructs arithmetic processing, storage access, or the like after data reading and sends the information to the storage access unit 13.

The fetch unit 16 obtains an instruction necessary for execution by the processor 1 from the instruction storage unit 17 based on a memory address indicated by a program counter.

(Context Switching Operation)

The processor 1 usually operates the context switching when an interrupt request is generated, when a function is called. These two context switching operations will be described below with reference to the drawings.

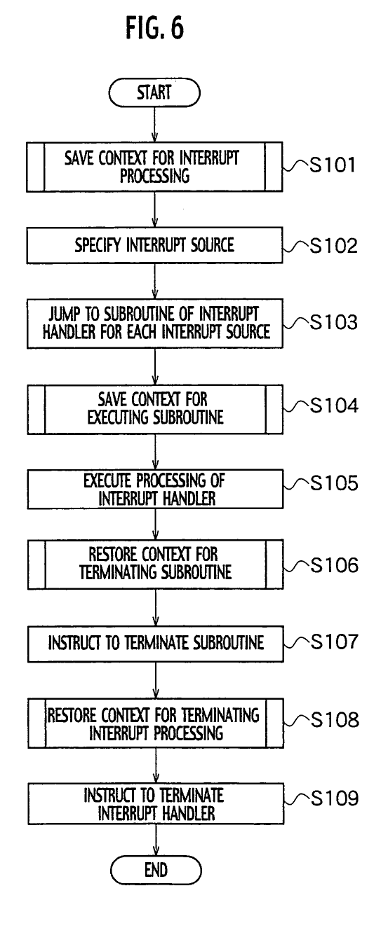

First, the operation when the interrupt request is generated will be described using a flowchart of FIG. 6.

(a) In step S101, the arithmetic unit 12 executes an instruction to save a context when an interrupt occurs during operation of the arithmetic unit 12, because an error occurs in an arithmetic result, because a processing request is received from peripheral equipment, or other reasons. The context saving process will be described in detail later. In step S102, the arithmetic unit 12 specifies the source of the interrupt. In the case where there are a plurality of interrupt sources, the arithmetic unit 12 determines interrupt priorities. In step S103, when the interrupt sources are determined, the arithmetic unit 12 temporarily suspends the processing which has been performed, then executes an interrupt handler for each interrupt source, and jumps to a subroutine indicated by the interrupt handler.

(b) In step S104, the arithmetic unit 12 executes an instruction to save a context of the subroutine to the register unit 10 in order to execute the subroutine. The context saving instruction will be described in detail later. In step S105, program processing previously set in the interrupt handler is executed.

(c) In step S106, the processing of the interrupt handler is completed, the arithmetic unit 12 executes an instruction to restore a context. In step S107, the interrupt handler completes this subroutine.

(d) After execution of the interrupt handler, in step S108, the arithmetic unit 12 executes the instruction to restore the saved context in order to complete the interrupt processing. The context restoring instruction will be described in detail later. At last, in step S109, the arithmetic unit 12 executes an instruction to complete the interrupt handler.

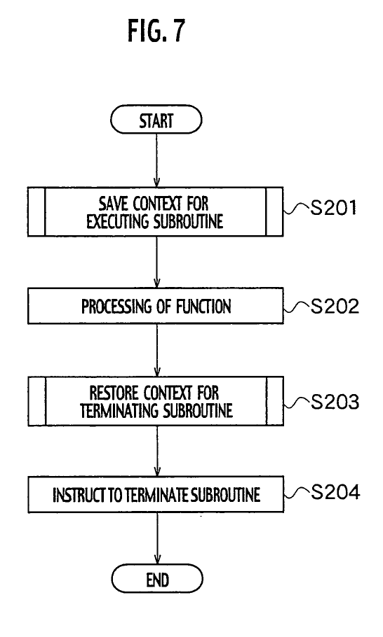

Next, a description of the operation when a function is called will be given in a flowchart of FIG. 7.

(a) In step S201, when a function call instruction is read, the arithmetic unit 12 executes the instruction to save a context in order to execute a subroutine. The context saving instruction will be described in detail later. In step S202, the arithmetic unit 12 executes processing of the called function as the subroutine.

(b) In step S203, when the processing of the called function is completed, the arithmetic unit 12 executes a instruction to restore the context in order to terminate the subroutine. The context restoring instruction will be described in detail later. In step S204, the arithmetic unit 12 terminates the subroutine of the function call.

(Context Saving Operation)

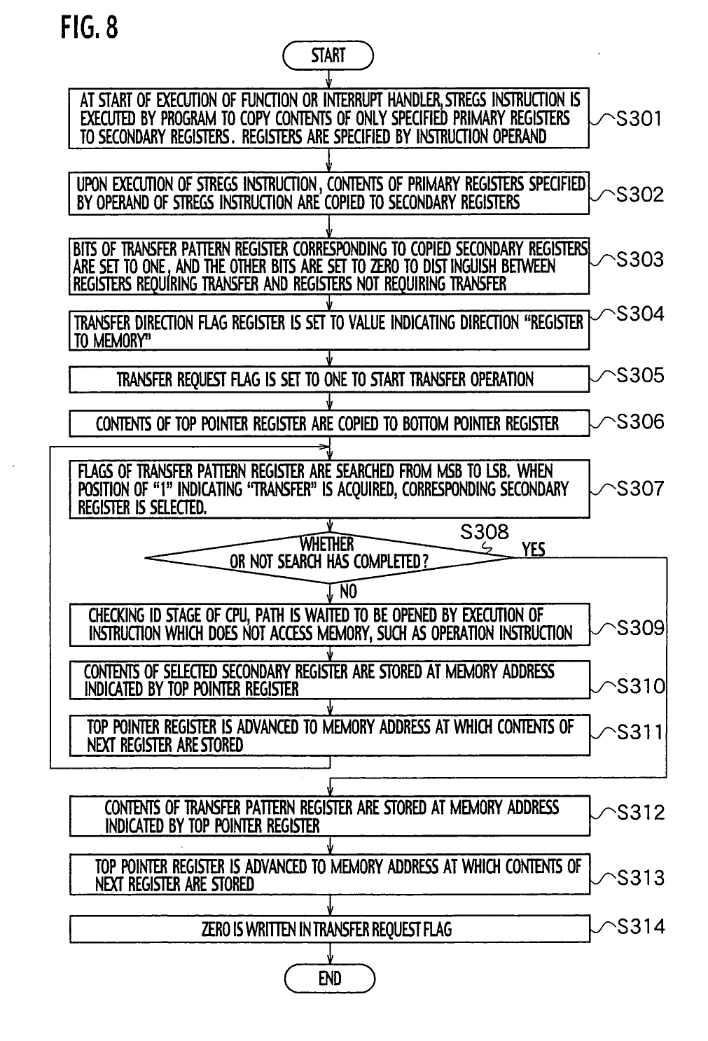

Next, a description of the switching operation for saving a context in execution of the stregs instruction will be given using a flowchart of FIG. 8. The bottom and top pointers for registers of the register unit 10 are assumed to indicate a context save area as shown in FIG. 4A as the initial state.

(a) In step S301, at the start of a called function or an interrupt handler, the arithmetic unit 12 executes the stregs instruction to copy only specified data in the primary register 10a to the secondary register 10b. Registers, contents of which are to be copied, are specified by an instruction operand.

(b) In step S302, when the the arithmetic unit 12 executes the instruction, contents of only data of the primary register 10a specified by the instruction operand are copied to the secondary register 10b. In step S303, flags of the pattern flag of the transfer pattern section 23 corresponding to the registers of the secondary register 10b to which the contents of the primary register 10a are copied are set to “1” to indicate the need for transfer. In the case where the transfer is not required, flags are set to “0”. In step S304, the direction flag of the transfer direction flag section 24 is set to indicate the transfer direction from the secondary register 10b to the data storage unit 14.

(c) In step S305, the transfer flag of the transfer request flag section 25 is turned ON (“1”) from OFF (“0”) to start the operation of transfer to the data storage unit 14. In step S306, the contents of the top pointer section 22 are copied to the bottom pointer section 21. In step S307, the pattern flag of the transfer pattern section 23 of FIG. 1 is checked sequentially from the MSB side to the LSB side. In the case where the transfer is available, data of the corresponding register of the secondary register 10b is read and written as shown in FIG. 4B at a memory address indicated by the top pointer. Subsequently, the pattern flag is checked again sequentially from the MSB side to the LSB side. When a position of “1” indicating the need for transfer is obtained, a corresponding register of the secondary register 10b is selected, and transfer is started.

(d) In step S308, it is judged whether the search of all the flags of the pattern flag is completed. When it is judged that the search is completed, the procedure proceeds to step S312, and when it is judged that the search continues to be performed, the procedure proceeds to step S309.

In step S309, an instruction which does not access the data storage unit 14, such as an operation instruction, is waited to be executed, that is, a path to the data storage unit 14 is waited to open while an ID stage of the arithmetic unit 12 is checked. In step S310, when the path to the data storage unit 14 opens, the contents of the selected register are stored at a memory address indicated by the top pointer. In step S311, the top pointer is advanced to a memory address at which contents of a register are to be stored next. In the embodiment, the memory addresses are given in bytes. The data length of the general-purpose registers 18a and the like is 32 bit, and the width of data transferred at once is 32 bits. Accordingly, the contents of the top pointer increases by 4. Then, the procedure returns to the step S307, and the transfer process is performed again in the same manner.

(e) In step S312, when the contents of the pattern flag of the transfer pattern section 23 are read and the operation of the transfer from the secondary register 10b to the data storage unit 14 is completed, the contents of the pattern flag are written at the memory address indicated by the top pointer as shown in FIG. 4C. In step S313, the top pointer of the top pointer section 22 is increased by 4 to indicate the memory address at which next writing is performed. In step S314, the transfer flag of the transfer request flag section 25 is turned OFF, that is, set to “0”, and the operation of transfer to the data storage unit 14 is terminated.

(Context Restoring Operation)

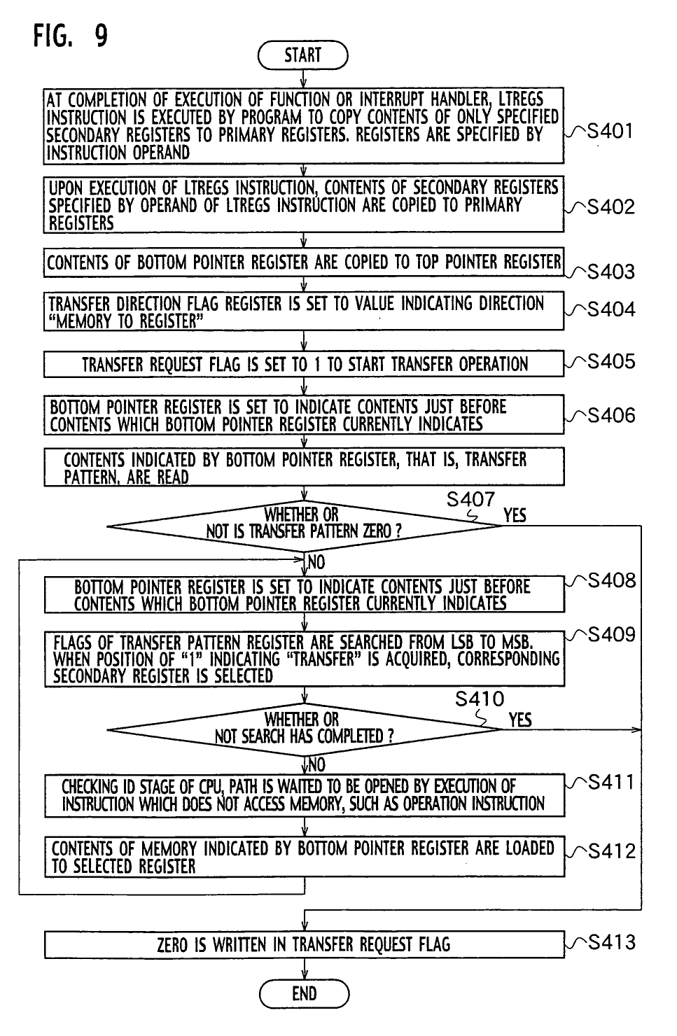

Next, a description will be given of the operation of context switching when the ldregs instruction is executed for restoring a context using the flowchart of FIG. 9. The initial state of the bottom and top pointers of the registers of the register unit 10 is the state of FIG. 5A where contexts are saved in the data storage unit 14 by performing context switching twice.

(a) First, in step S401, when execution of a function or an interrupt handler is completed, the arithmetic unit 12 executes the ldregs instruction to copy contents of only specified registers of the secondary register 10b to the primary register 10a. Herein, the registers are specified by an instruction operand. When the ldregs instruction is executed, the instruction is stalled into a standby state when the transfer flag of the transfer request flag section 25 is “ON”. The instruction is executed at a cycle following a cycle in which the transfer flag is turned “OFF”.

(b) In step S402, when the transfer flag is turned OFF, the arithmetic unit 12 copies contents of only registers of the secondary register 10b specified by the instruction operand to the primary register 10a. In step S403, the contents of the bottom pointer section 21 are copied to the top pointer section 22. In step S404, the direction of transfer from the data storage unit 14 to the register is set at the direction flag of the transfer direction flag section 24. In step S405, the transfer flag of the transfer request flag section 25 is turned from OFF to ON to start the transfer operation.

(c) Instructed to start transfer, the arithmetic unit 12 decreases the bottom pointer of the bottom pointer section 21 by 4 in step S405. In step S406, the contents indicated by the bottom pointer section 21 is read from the data storage unit 14. In step S407, when the contents indicated by the bottom pointer section 21 are “0”, the procedure proceeds to step S413. When the contents indicated by the bottom pointer section 21 are not “0”, the procedure proceeds to step S408.

(d) In the step S408, the read data is written in the transfer pattern section 23, and the contents of the register of the bottom pointer section 21 is decreased by 4. In step S409, the flags of the pattern flag of the updated transfer pattern section 23 are sequentially checked from the LSB side. When “1” indicating the need for transfer is obtained, data is read from a memory address indicated by the bottom pointer and then written into a register of the secondary register 10b corresponding to the flag indicating the need for transfer.

Moreover, the bottom pointer of the bottom pointer section 21 is decreased by 4. In step S410, it is judged whether the search for all the flags of the pattern flag is completed while the pattern flag of the transfer pattern section 23 is sequentially checked from the LSB to the MSB. When the search for all the flags is completed, the procedure proceeds to the step S413, and when the search is continued, the procedure proceeds to step S411.

(e) In the step S411, an instruction which does not access the data storage unit 14, such as an operation instruction, is waited to be executed, that is, a path to the data storage unit 14 is waited to open while the ID stage of the arithmetic unit 12 is checked. When the path to the data storage unit 14 opens, the selected register is stored in the memory address indicated by the bottom pointer. In the step S311, the bottom pointer is advanced to a memory address at which contents of a register are to be stored next.

(f) When the processing for all the flags of the pattern flag is completed in this manner, the transfer flag of the transfer request flag section 25 is turned OFF in step S413 to terminate the operation of transfer from the data storage unit 14 to the registers.

In the embodiment of the present invention, the primary register 10a and the secondary section 10b are connected to each other one on one, and data transfer therebetween is performed in a cycle. Data transfer between the secondary register 10b and the data storage unit 14 is performed by sharing a bus of an internal data memory of the processor 1 to reduce the increase in hardware units.

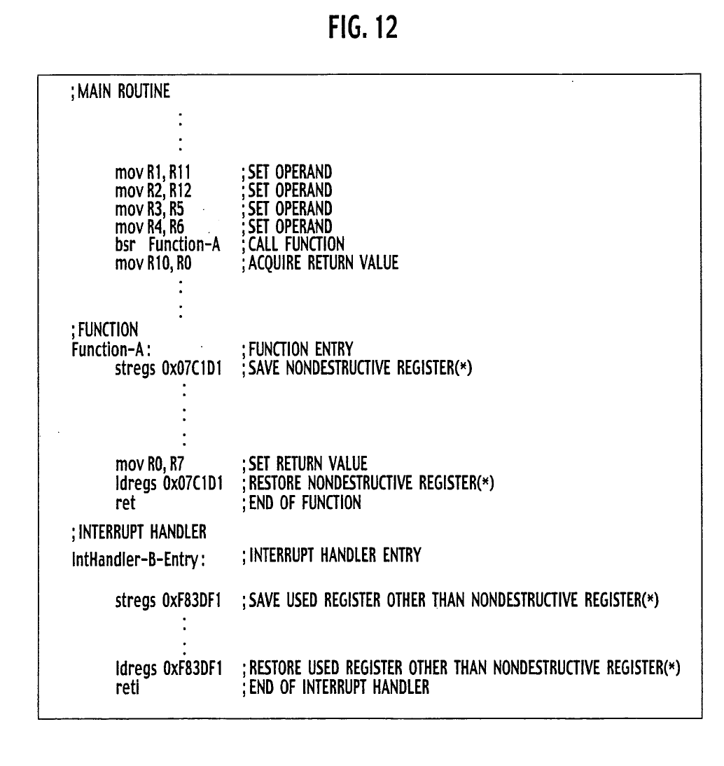

FIG. 12 shows an example of a source code using the stregs and ldregs instructions when an interrupt occurs or when a function is called.

The processor 1 according to the embodiment of the present invention can implement a processing program for saving and restoring a context which is necessary in a program called by an interrupt processing program or a subroutine in interrupt processing with two instructions of the stregs and ldregs instructions. Accordingly, the program size can be reduced, and the processing speed of context switching can be increased. Moreover, data transfer to save/restore a context from/to the registers to/from the data storage unit 14 can be carried out in parallel to instruction execution by the processor 1.

The transfer time is hidden, and high speed context switching can be implemented. Furthermore, any redundant operations of copy within the register unit 10 and data transfer to the data storage unit 14 are not performed. Therefore, the number of operating circuits is reduced, and the power consumption can be reduced.

### EXAMPLE 1

The context switching operation according to the embodiment of the present invention operates using only the primary register 10a in normal instruction execution. When an interrupt is accepted or when the subroutine call instruction is executed, copy or data transfer is performed for register contents in a flow of the primary register 10a, the secondary register 10b, to the data storage unit 14 using the stregs instruction or in a flow of the data storage unit 14, the secondary register 10b, to the primary register 10a using the ldregs instruction.

However, the context switching operation can be implemented by performing copy between the primary and secondary registers 10a and 10b by use of another instruction without the stregs and ldregs instructions. The example of the source code using the stregs and ldregs instructions when an interrupt occurs or when a function is called in the embodiment is shown in FIG. 12, and, in the modified example 1, it is possible to omit codes of “saving registers” and “restoring registers” indicated by * in the source code.

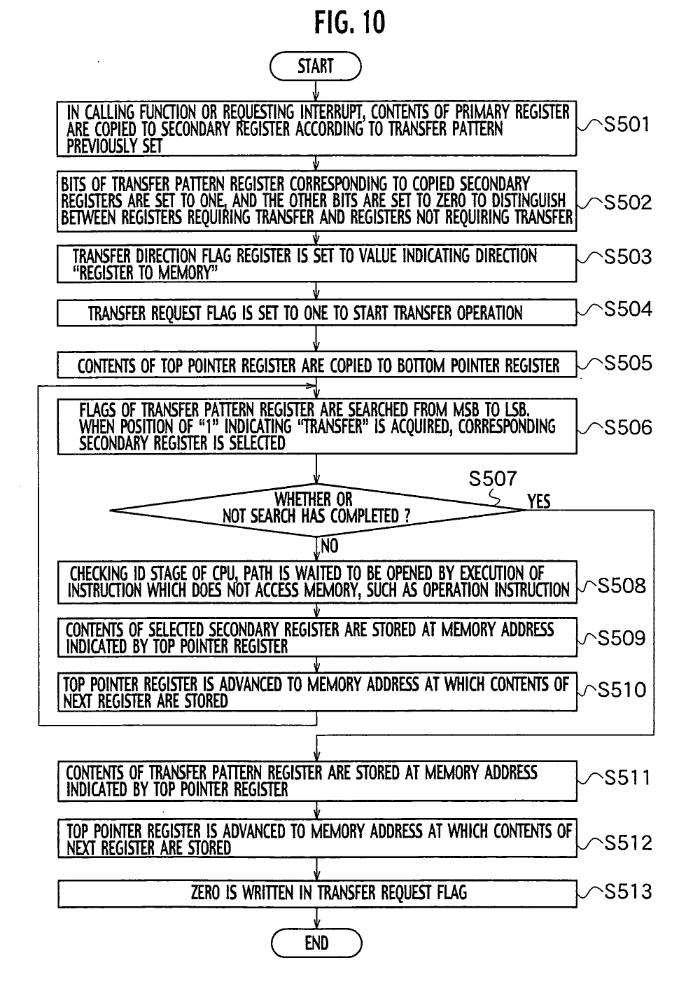

FIG. 10 shows a flowchart of an operation of “saving registers” in the case of omitting the copy between the primary and secondary registers 10a and 10b. In step S501, a new instruction to perform the copy operation from the primary register 10a to the secondary register 10b is added in preparation for the stregs instruction. Alternatively, a copy flag is provided for the PSW, and the copy operation is controlled by a status of the copy flag. The use of the PSW eliminates the need for adding a new instruction code.

After completion of this preparation process, the processor 1 transfers data of only registers of the secondary register 10b indicated by an instruction operand to the data storage unit 14 using the stregs instruction in steps S502 to S513. The operations of the steps S502 to S513 are the same as those of the steps S302 to S314 in the embodiment, and the description thereof is omitted.

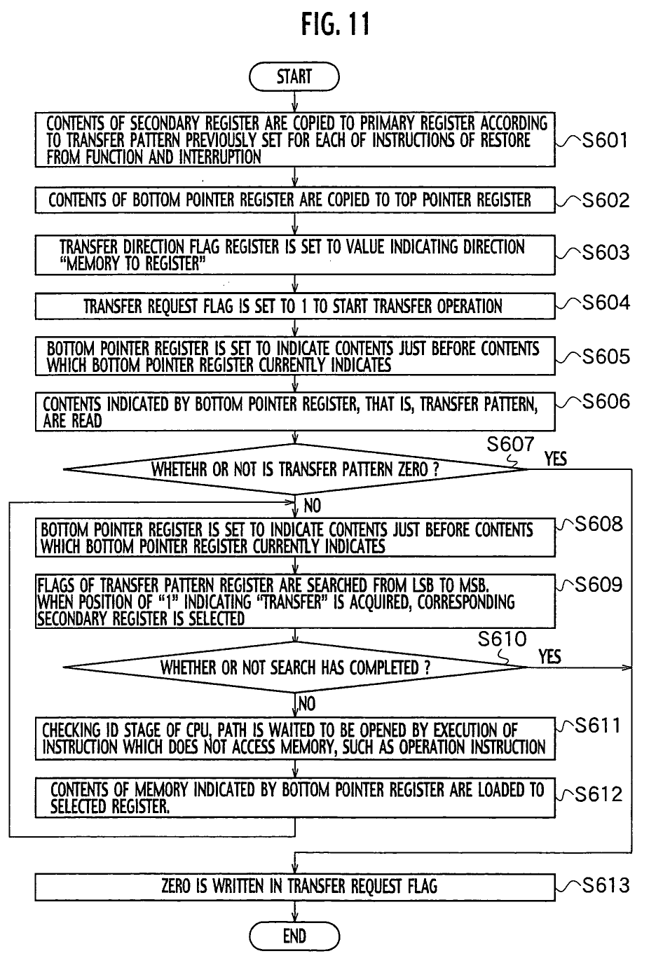

FIG. 11 shows a flowchart of the operation of “restoring registers” in the case of omitting the copy between the primary and secondary registers 10a and 10b. In step S601, a new instruction to perform the copy operation from the secondary register 10b to the primary register 10a is added in preparation for the ldregs instruction, or the copy operation is controlled using the PSW.

After completion of the preparation process, the processor 1 transfers only data of the data storage unit 14 indicated by an instruction operand to the secondary register 10b using the ldregs instruction in steps S602 to S613. The operations of the steps S602 to S613 are the same as those of the steps S402 to S413 in the embodiment, and the description thereof is omitted.

The data transfer between the data storage unit 14 and the secondary register 10b is performed in parallel to instruction execution by the processor 1 when the instruction execution by the processor 1 does not involve memory access.

As described above, it is possible to increase the degree of freedom in producing a program using the stregs and ldregs instructions.

### EXAMPLE 2

In execution of the ldregs instruction, contents of specified registers of the secondary register 10b are copied to the primary register 10a. However, the registers may be specified not by using the instruction operand but by using the pattern flag of the transfer pattern section 23.

The use of the pattern flag as described above eliminates the need for the instruction operand part which specifies registers. Accordingly, the code size of the ldregs instruction can be reduced, and the program size can be reduced, thus increasing the processing speed.

### EXAMPLE 3

The flags of the pattern flag of the transfer pattern section 23 are not necessarily provided for respective registers. A plurality of the registers may be treated as a group, and the need for transfer may be specified in groups.

The treatment of registers in groups can reduce the increase in size of the instruction operand even if contexts of the processor 1 are increased or even if the numbers of specified general-purpose registers 18a and 18b and the dedicated registers 19a and 19b are increased. Therefore, it is possible to suppress the increase in program size and decrease the reduction in the processing speed.

The present invention may be embodied in other specific forms without departing from the spirit or essential characteristics thereof. The embodiments are therefore to be considered in all respects as illustrative and not restrictive, the scope of the present invention being indicated by the appended claims rather than by the foregoing description, and all changes which come within the meaning and range of equivalency of the claims are therefore intended to be embraced therein.

1. A processor, comprising:
a register unit configured to include a primary register used in program execution by the processor and a secondary register having a same structure as the primary register;
a data storage unit configured as a data storage area in the program execution;
a transfer unit configured to include a transfer register for data transfer between the secondary register and the data storage unit; and
an arithmetic unit configured to cyclically perform copying between the primary and secondary registers and perform the data transfer between the data storage unit and the secondary register in parallel in response to an instruction by the processor when the instruction by the processor fails to involve memory access to the data storage unit.

2. The processor of claim 1, wherein the arithmetic unit further comprises:
a register storing unit configured to copy data of a register of the primary register specified by an instruction operand and transfer the copied data of the secondary register to the data storage unit in accordance with a predetermined sequence; and
a register loading unit configured to copy data of the register copied to the secondary register by the register storing unit to the primary register and which, when data of the secondary register to be transferred remains in the data storage unit, transfers the data from the data storage unit to the secondary register.

3. The processor of claim 1, wherein the transfer unit includes the transfer register comprises:
a transfer direction flag section which stores a direction flag indicating a direction of data transfer between the register unit and the data storage unit;
a transfer request flag section which stores a transfer flag instructing start of data transfer between the register unit and the data storage unit and indicating a transfer state; and
a transfer pattern section which stores a pattern flag controlling for each register whether the copy between the primary and secondary registers or the transfer between the secondary register and the data storage unit is performed.

4. The processor of claim 1, wherein the data transfer between the data storage unit and the secondary register is performed through an identical data memory bus in the processor.

5. The processor of claim 1, wherein the arithmetic unit further comprises:
a register storing unit configured to transfer data of the secondary register to which data of the primary register are copied to the data storage unit in accordance with a predetermined sequence; and
a register loading unit configured to transfer the data from the data storage unit to the secondary register when data of the secondary register to be transferred remains in the data storage unit.

6. The processor of claim 5, wherein copying between the primary register and the secondary register is performed by a copy command which is independence from the register loading unit.

7. The processor of claim 5, wherein copying between the primary register and the secondary register is performed by a copy flag of a processor states word in dedicated registers.

8. A method for performing context switching within a processor, comprising:
copying data of a register within a primary register specified by an instruction operand for a processor executing to a secondary register;
transferring the copied data of the secondary register to a data storage unit in accordance with a predetermined sequence;
copying data of a register of the secondary register to which the data of the primary register are copied to the primary register; and
transferring the data from the data storage unit to the secondary register in parallel when data of the secondary register to be transferred remains in the data storage unit, in response to an instruction by the processor when the instruction by the processor fails to involve memory access to the data storage unit.

9. The method of claim 8, further comprising:
copying data of a register of the primary register specified by an instruction operand and transferring the copied data of the secondary register to the data storage unit in accordance with a predetermined sequence; and
copying data of the register copied to the secondary register by the register storing unit to the primary register and which transferring the data from the data storage unit to the secondary register when data of the secondary register to be transferred remains in the data storage unit.

10. The method of claim 8, wherein the transferring the data from the data storage unit to the secondary register by the transfer registers comprises:
storing a direction flag indicating a direction of data transfer between the register unit and the data storage unit;
storing a transfer flag instructing start of data transfer between the register unit and the data storage unit and indicating a transfer state; and
storing a pattern flag controlling for each register whether the copy between the primary and secondary registers or the transfer between the secondary register and the data storage unit is performed.

11. The method of claim 8, wherein the data transfer between the data storage unit and the secondary register is performed through an identical data memory bus in the processor.

12. The method of claim 8, further comprising:
transferring data of the secondary register to which data of the primary register are copied to the data storage unit in accordance with a predetermined sequence; and
transferring the data from the data storage unit to the secondary register when data of the secondary register to be transferred remains in the data storage unit.

13. The method of claim 12, wherein the copy between the primary register and the secondary register is performed by a copy command which is independence from the register loading unit.

14. The method of claim 12, wherein the copy between the primary register and the secondary register is performed by a copy flag of a processor states word in dedicated registers.

15. A computer program configured to perform context switching within a processor, the computer program causing a computer to execute instructions for:
copying data of a register within a primary register specified by an instruction operand for a processor executing to a secondary register;
transferring the copied data of the secondary register to a data storage unit in accordance with a predetermined sequence;
copying data of a register of the secondary register to which the data of the primary register are copied to the primary register; and
transferring the data from the data storage unit to the secondary register in parallel when data of the secondary register to be transferred remains in the data storage unit, in response to an instruction by the processor when the instruction by the processor fails to involve memory access to the data storage unit.

16. The program of claim 15, comprising:
copying data of a register of the primary register specified by an instruction operand and transferring the copied data of the secondary register to the data storage unit in accordance with a predetermined sequence; and
copying data of the register copied to the secondary register by the register storing unit to the primary register and which transferring the data from the data storage unit to the secondary register when data of the secondary register to be transferred remains in the data storage unit.

17. The program of claim 15, wherein the transferring the data from the data storage unit to the secondary register by the transfer registers comprises:
storing a direction flag indicating a direction of data transfer between the register unit and the data storage unit;
storing a transfer flag instructing start of data transfer between the register unit and the data storage unit and indicating a transfer state; and
storing a pattern flag controlling for each register whether the copy between the primary and secondary registers or the transfer between the secondary register and the data storage unit is performed.

18. The program of claim 15, further comprising:
transferring data of the secondary register to which data of the primary register are copied to the data storage unit in accordance with a predetermined sequence; and
transferring the data from the data storage unit to the secondary register when data of the secondary register to be transferred remains in the data storage unit.

19. The program of claim 18, wherein the copying between the primary register and the secondary register is performed by a copy command which is independence from the register loading unit.

20. The program of claim 18, wherein the copying between the primary register and the secondary register is performed by a copy flag of a processor states word in dedicated registers.
